(19) United States
(12) Patent Application Publication
(10) Pub. No.: US 2005/0288421 A1
(43) Pub. Date: Dec. 29, 2005

(54) Foams of enhanced flame resistance, articles formed therefrom and related method

(76) Inventors: John Burns, Simpsonville, SC (US); Kim Van Voorhis, Rutherfordton, NC (US); George Hairston, Spartanburg, SC (US); Warren Stidham, Cohutta, GA (US)

Correspondence Address: JAMES M. ROBERTSON, 233 SOUTH PINE STREET, SPARTANBURG, SC, 29302, US

(21) Appl. No.: 10/992,127

(22) Filed: Nov. 18, 2004

Related U.S. Application Data
(60) Provisional application No. 60/523,467, filed on Nov. 19, 2003.

(51) Int. Cl. C08K 5/02

(52) U.S. Cl. 524/464

(57) ABSTRACT

A cellular foam composition including at least one base polyol intermixed with a non-brominated intumescent flame retardant composition. The cellular foam is characterized by enhanced flame resistance.

### CROSS-REFERENCE TO RELATED APPLICATIONS

This application claims the benefit of and priority from U.S. provisional application 60/523,467 filed Nov. 19, 2003, the contents of which are incorporated by reference herein in their entirety.

### TECHNICAL FIELD

This invention relates generally to foams such as urethane foams and the like and articles formed therefrom which incorporate a non-brominated flame retardant additive of intumescent character to provide enhanced resistance to flammability.

### BACKGROUND OF THE INVENTION

Urethane foams are well known and are used in a number of environments to provide cushioning, sound insulation and other desirable properties. In a number of environments where foams are used it may also be desirable to have a degree of flammability resistance. By way of example only, such environments may include automotive and aeronautic applications, appliances, furniture, bedding, building materials and the like.

In the past, flame resistance has often been achieved in urethane foams by addition of brominated flame retardants. The use of brominated materials such as decobromodiphenyl oxide and polybrominated diphenyl ethers (PBDEs) has been particularly common in such applications. While such materials have provided generally good levels of flame retardancy, it is now believed that such materials may give rise to undesirable health problems in some users.

### SUMMARY OF THE INVENTION

The present invention provides advantages and alternatives over the prior art by providing polyurethane foams which incorporate an intumescent flame retardant composition of non-brominated character as well as a method of producing such foams. The flame retardant composition may be blended directly into a mixture of base urethane polyols. Optional additions may also be made such as appropriate cross linking agents such as MDI or TDI and/or surfactants such as silicone or the like and/or various catalysts. The resulting foam mixture may be either mechanically frothed or chemically blown to form the desired cell structure.

### DESCRIPTION OF PREFERRED EMBODIMENTS

While the present invention has been generally described above and will hereinafter be described in conjunction with certain potentially preferred embodiments procedures, and practices, it is to be understood that in no case is the invention to be limited to such described embodiments, procedures, and practices. On the contrary, it is intended that the present invention shall extend to all alternatives, modifications, and equivalents as may embrace the principles of the present invention within the true scope and spirit thereof.

According to a potentially preferred practice, the flame retardant composition is of a so called “intumescent” character which is characterized by undergoing a swelling and charring when exposed to substantial heat. By way of example only, and not limitation, the flame retardant composition preferably contains (i) a blowing agent such as melamine, urea, dicyandiamide or combinations thereof; (ii) an acid donor such as ammonium polyphosphate, mono-ammonium phosphate, diammonium phosphate, potassium tripolyphosphate or combinations thereof; (iii) a carbon donor such as dipentaerythritol (DPE), pentaerythritol, polyol, or combinations thereof; and (iv) a chlorinated paraffin wax.

According to one potentially preferred practice the flame retardant composition will contain about 0 to 90 percent by weight melamine, more preferably about 10 to 80 percent melamine and most preferably about 40 percent by weight melamine. The flame retardant composition will preferably contain about 0 to 90 percent by weight ammonium polyphosphate, more preferably about 5 to 40 percent by weight ammonium polyphosphate and most preferably about 20 percent by weight ammonium polyphosphate. The flame retardant composition will preferably contain about 0 to 90 percent by weight chlorinated paraffin wax, more preferably about 5 to 40 percent by weight chlorinated paraffin wax and most preferably about 20 percent by weight chlorinated paraffin wax. By way of example only, one such chlorinated paraffin wax which is believed to be suitable is marketed under the trade designation CHLOROWAX 70 from Dover Chemical in Dover Ohio. The flame retardant composition will preferably contain about 0 to 90 percent by weight pentaerythritol, more preferably about 5 to 40 percent by weight pentaerythritol and most preferably about 20 percent by weight pentaerythritol. Of course, all such percentages are exemplary only and may be varied as desired.

In practice it is contemplated that the flame retardant composition may be intermixed directly with the base foam polyol mixture. It is contemplated that a wide range of polyols as will be known to those of skill in the art may be utilized and that the invention is in no way to be limited to a particular polyol. It is contemplated that the weight percentage of the flame retardant composition may vary widely depending on the foam properties and flame resistance desired. However, in general it is believed that the flame retardant composition will preferably range between about 10% to about 200% by weight relative to the polyol. By way of example only, and not limitation, one suitable composition has incorporated the flame retardant composition at a level of about 150% by weight relative to the polyol. Of course, it is contemplated that such percentages may be readily adjusted as desired thereby providing substantial flexibility in the process.

Following blending of the polyol and flame retardant composition it is contemplated that a cross-linking agent such as MDI (Diphenylmethane Diisocyanate) or TDI (Toluene Diisocyanate) as will be well known to those of skill in the art may be added at an effective amount. Addition of a silicone surfactant may also be utilized in a manner as will be well known to those of skill in the art. Such a silicone surfactant addition may be particularly beneficial if mechanical foaming is to be utilized. The composition may also include various catalysts such as tin, zinc or the like as will be known to those of skill in the art. Blowing of the foam to the desired density may be carried out by standard practices including water addition in reactive foam compositions and/or by the introduction of Freon, nitrogen, carbon dioxide or other gaseous blowing agents. Of course, processing may be adjusted to make the product stiffer or softer as desired including foams having light weight and substantial cushioning resilience as well as foams of so called “tacky” or “dead” character. It is also contemplated that a wide range of fillers such as calcium carbonate, ATH, clay, fly ash, glass spheres, magnesium hydroxide, carbon black and the like may be added as desired to adjust density, resiliency or other properties.

It has been found that foams incorporating the flame retardant compositions are characterized by flame resistance at levels comparable to those of prior brominated foams without the inclusion of brominated additives. Accordingly, it is believed that the present invention provides substantial advantages over the prior art.

It will be appreciated that the flame retardant foams of the present invention may find application in an almost unlimited array of uses. By way of example only, various end uses may include automotive and aeronautic applications including seat cushions, upholstery backings, headliners, door coverings, trunk liners, backings for dash panels, steering wheels and the like as well as cushioning and upholstery backings for furniture, bedding, mattresses and the like, sound and heat insulation for appliances and various building materials.

While the present invention has been described in relation to certain potentially preferred embodiments and practices, it is to be understood that such embodiments and practices are illustrative and exemplary only and that the present invention is in no event to be limited thereto. Rather, it is contemplated that modifications and variations to the present invention will no doubt occur to those of skill in the art upon reading the above description and/or through a practice of the invention. It is therefore contemplated and intended that the present invention shall extend to all such modifications and variations which incorporate the broad principles of the present invention within the full spirit and scope thereof.

1. A cellular foam composition comprising at least one base polyol intermixed with a non-brominated intumescent flame retardant composition such that cellular foam is characterized by enhanced flame resistance.

2. The invention as recited in claim 1, wherein the flame retardant composition comprises an acid donor, a carbon donor and a blowing agent.

3. The invention as recited in claim 1, wherein the flame retardant composition comprises an acid donor, a carbon donor and a blowing agent and a chlorinated paraffin wax.

4. A cellular foam composition comprising at least one base polyol intermixed with a non-brominated intumescent flame retardant composition such that cellular foam is characterized by enhanced flame resistance, wherein the foam composition is polyurethane foam and wherein the flame retardant composition comprises an acid donor, a carbon donor and a blowing agent.

5. A cellular foam composition comprising at least one base polyol intermixed with a non-brominated intumescent flame retardant composition such that cellular foam is characterized by enhanced flame resistance, wherein the foam composition is polyurethane foam, wherein the flame retardant composition comprises an acid donor, a carbon donor and a blowing agent, and wherein the foam composition further includes a cross-linking agent and a silicone surfactant.
